(19) United States
(12) Patent Application Publication
(10) Pub. No.: US 2004/0042800 A1
(43) Pub. Date: Mar. 4, 2004

(54) All-optical 3R regenerator using solitary wave interactions

(76) Inventor: Brian L. Lawrence, Clifton Park, NY (US)

Correspondence Address: Brian L. Lawrence, 47 Dorsman Drive, Clifton Park, NY, 12065, US

(21) Appl. No.: 10/653,513

(22) Filed: Sep. 2, 2003

Related U.S. Application Data
(60) Provisional application No. 60/406,754, filed on Aug. 30, 2002.

(51) Int. Cl. H04B 10/17

(52) U.S. Cl. 398/175; 398/155

(57) ABSTRACT

A method and apparatus for all-optical signal regeneration in fiber optic communications networks is provided. The process utilizes solitary wave interactions in various nonlinear optical media to re-shape, re-amplify and re-time optical signals that have traveled over large distances of fiber-optic cable. The device consists of an optical clock generator synchronized to the system clock, recovered from the input signal by a clock recovery unit. The output of the optical clock is then used to produce a solitary wave in the nonlinear material that collides with the coincident signal beam. The net result is an all-optical signal regenerator. A multi-channel device capable of providing signal regeneration on multiple wavelengths using a single clock recovery and optical clock generator assembly is also disclosed.

### CROSS-REFERENCE TO RELATED APPLICATIONS

This application claims the benefit of U.S. Provisional Application No. 60/406,754 filed Aug. 30, 2002, entitled ALL-OPTICAL 3R REGENERATOR USING SOLITARY WAVE INTERACTIONS. The Provisional Application is hereby incorporated by reference herein in its entirety.

### FIELD OF THE INVENTION

The present invention relates to fiber optic communication. More particularly, the present invention relates to a method and apparatus for all-optical regeneration of an optical signal.

### BACKGROUND OF THE INVENTION

As the traffic carried by long-haul fiber optic networks continues to grow, new systems must be deployed to handle the increase. However, given the dramatic collapse of the telecommunications industry in 2001, companies in the telecommunications industry now look for new hardware to not only carry the increased traffic load with room to grow, but also at a reduced cost both to purchase and to operate. These metrics combine to drive service providers to purchase equipment that can support higher speeds to carry more traffic and at the same time is lower cost.

To satisfy these requirements, new equipment purchases will largely be 10 Gb/s and 40 Gb/s that utilize technology to drive not only speed increases but cost reductions as well. In long haul networks, the dominant cost driver is signal regeneration. This is driven largely by the fact that regeneration is typically done using an optical-to-electrical-to-optical conversion process. In this process, the optical signal is converted to an electrical one re-shaped and re-timed electrically and then transmitted the next span of optical fiber by a laser. Prior to long distance transmission, an optical amplifier is typically used to amplify the signal. Because the process involves detection and transmission by photodetectors and lasers, respectively, each wavelength requires an individual set of hardware. Once the distance threshold is crossed and signal regeneration is required, regenerators compose at least 50% and as much as 75% of the total cost of a long-haul optical transport system. Thus there exists a need in the long-haul telecommunications industry for optical signal regeneration processes and equipment that can dramatically reduce the hardware required and consequently the cost while also providing the flexibility of working at various data transmission rates.

The present invention discloses a solitary wave interaction process and associated hardware design that can provide complete 3R optical regeneration at any data transmission rate and can do so at a dramatically reduced cost.

### SUMMARY OF THE INVENTION

The shortcomings of the prior art are overcome, and additional advantages are provided, by the apparatus, methods and techniques of present invention which in one aspect is an all-optical regenerator having an optical signal input node for receiving an input optical signal, the input optical signal including data; and a regenerator waveguide receiving the input optical signal and an optical clock signal, and producing an output optical signal re-timed according to the optical clock signal and re-shaped according to the data in the input optical signal.

The regenerator waveguide provides amplification of the output optical signal relative to the input optical signal, and may employ temporal soliton interactions. The temporal soliton interactions may include cascaded quadratic non-linear solitons or saturating third-order non-linear solitons.

The regenerator may include a clock recovery unit for recovering timing information from the input optical signal; and an optical clock generator to produce the optical clock signal synchronous with the timing information recovered by the clock recovery unit.

The optical clock generator may include a mode-locked laser, an optical delay line, an optical amplifier and an optical frequency doubler, cascaded in series, to generate the optical clock signal.

A plurality of optical signal input nodes may be provided, each for receiving a respective input optical signal at a respective wavelength. A plurality of regenerator waveguides may also be provided, each receiving a respective input optical signal and the optical clock signal, and producing a respective output optical signal at its respective wavelength re-timed according to the optical clock signal and re-shaped according to the data in its respective input optical signal, wherein the optical clock signal is synchronous with the timing information recovered from one of the input optical signals, and shared between the plurality of regenerator waveguides.

The process and design disclosed in the present invention provides for complete signal regeneration for fiber optic networks. The present invention discloses the use of solitary wave interactions in various nonlinear optical media to affect complete signal regeneration, which includes temporal re-shaping of the signal pulse, re-timing of the data stream to the system clock, and re-amplifying the signal level. The all-optical process has numerous advantages over existing and proposed signal regeneration methods.

Current state of the art technology for signal regeneration involves optical-to-electronic-to-optical (OEO) conversions, in which the optical signal is converted to the electronic domain, regenerated, and subsequently re-transmitted. The all-optical (OOO) process of this invention does not require any conversion of the signal into the electronic domain. As a consequence of the absence of any intervening electronics, the all-optical process has no underlying dependence on the transmission rate. Ultimately, the all-optical signal regeneration technology offers an extremely flexible solution that can easily upgrade to faster transmission rates.

In addition, OEO processes require that the signal be re-transmitted following regeneration. As a consequence, each wavelength in a wavelength division multiplexed (WDM) system requires a complete set of independent signal regeneration hardware. The all-optical process of the present invention offers the potential to share the clock recovery, clock generator, delay line, amplifier, and frequency doubling waveguide among multiple channels, requiring only that polarization controllers and nonlinear optical waveguides be duplicated. This ability to share equipment across channels offers dramatic cost reduction potential.

In addition to current technology, the disclosed all-optical signal regeneration process also offers advantages over other proposed optical techniques. The dominant all-optical regeneration technology consists of a series of semiconductor optical amplifiers (SOAs) used as gates to transfer the data signal to a clean pulse train generated by a local source. Because this process transfer data from one pulse train to another, each wavelength requires a local source of that same wavelength. As a consequence, the costs can be prohibitive as sources of pulse trains at data rates of 10 Gb/s or higher can be very expensive. The all-optical process of the present invention does not transfer data, but instead physically regenerates the original data stream. Thus the optical clock can be used for multiple different wavelengths.

### BRIEF DESCRIPTION OF THE DRAWINGS

The subject matter is regarded as the invention is particularly pointed out and distinctly claimed in the concluding portion of the specification. The invention, however, both as to organization and method of practice, together with further objects and advantages thereof, may be best understood by reference to the following detailed description of the preferred embodiment(s) and the accompanying drawings in which:

FIG. 1 is a graphic representation of the self-focusing process in a nonlinear material;

FIG. 2 is a schematic representation of the cascaded quadratic optical nonlinear process using second harmonic generation;

FIG. 3 is a graphical representation of steering and switching of optical beams using soliton collisions;

FIG. 4 is a schematic representation of the input and output conditions and general waveguide structure for all-optical regeneration using a cascaded quadratic nonlinearity;

FIG. 5 is a block diagram of the single-channel all-optical 3R regenerator design;

FIGS. 6a and 6b are plots of signal intensity versus time showing the results of numerical simulations of the all-optical regeneration process for a distorted input signal, pump/clock, and output signal for a +5 picosecond offset;

FIGS. 7a and 7b are plots of signal intensity versus time showing the results of numerical simulations of the all-optical regeneration process for a distorted input signal, pump/clock, and output signal for a −5 picosecond offset; and

FIG. 8 is a block diagram of the multi-channel all-optical 3R regenerator design.

### BEST MODE FOR CARRYING OUT THE INVENTION

A. Overview

The all-optical signal regenerator disclosed is based on a fundamental technology platform that is composed of two related phenomena. The technology is founded on the principles of second-order and third-order nonlinear optics. Specifically, the technology uses nonlinear optical phenomena to strongly couple beams of light as they traverse a nonlinear optical material. The first facet of the technology is based on a process known as cascaded quadratic nonlinearities. The second part of the technology platform is the coupling of beams through third-order optical nonlinearities.

Regardless of which nonlinear optical phenomenon is used, the principles underlying the technology are the same: providing a means through which beams of light can be strongly coupled such that one beam can significantly affect another, or even act upon itself. This is not a new process, and is in fact the very same technology upon which soliton generation in optical fibers is based. Since the discovery of soliton generation in fibers over 20 years ago, numerous experimental studies have demonstrated soliton-like behavior in a wide variety of material systems. Fundamentally, solitons are pulses or beams of light that use nonlinear optical phenomena to offset the natural tendency of light to spread as it travels. The effect can manifest itself in two primary ways: time and space. In the time domain, light can be generated as either a continuous wave (cw) beam or as pulses. Pulses of light have a tendency to spread in time as they propagate due to natural dispersive effects. Temporal solitons, such as those occurring in optical fibers, can be created when the intensity dependent nonlinearity of a material offsets the dispersion. The result is a pulse that can propagate substantial distances without any significant broadening in time. In the space domain, beams of light are generated from, or focused to, finite dimensions. The smaller the area of the beam is the greater the tendency is for the beam to diffract or spread in the transverse dimensions as it propagates. Spatial solitons can be created when the intensity dependent nonlinearity of a material offsets diffraction. The result is a beam that can propagate substantial distances without a significant change in size or shape.

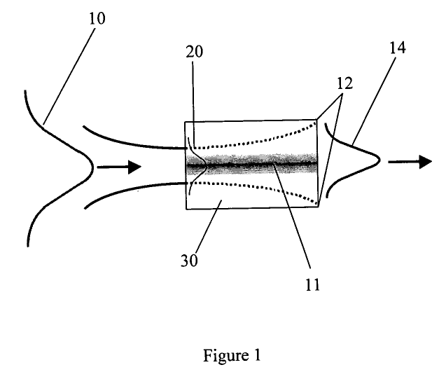

The key to soliton formation is the presence of a nonlinear response in the material in which the light propagates. Specifically, the material properties can be modified by the intensity of one or more of the propagating beams. There are several mechanisms through which this intensity dependence can be realized. However, where high-speed response combined with reasonably strong nonlinearity is required only a handful of phenomena can be used. The two technologies that form the technological platform of the invention are traditional third-order optical nonlinearities and cascaded quadratic nonlinearities. Third-order optical nonlinearities can provide an intensity-dependent response through the process of self-action, in which the refractive index of the material is dependent upon the intensity of the propagating beam (nmaterial=no+n2Iin). A reasonable model of spatial soliton generation in a third-order material is the process of self-focusing, as shown in FIG. 1. In this case, a beam with a Gaussian intensity profile (10) is incident on a third-order nonlinear material (30) producing an index variation that maps to the intensity profile (20). With a higher index towards the center of the beam, an effective lens is created that tends to offset the natural diffractive behavior (12), producing a beam that propagates without diffraction (11). The beam emerges at the output (14) equivalent to or smaller than the input beam. Similar behavior occurs in the time domain to create temporal solitons.

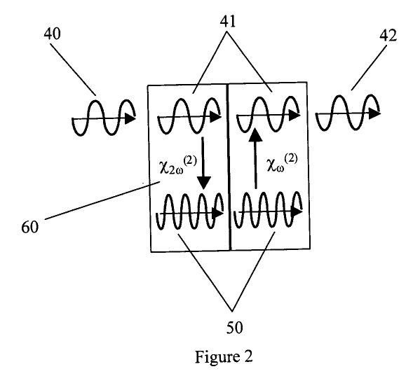

The other optical nonlinearity that is used to generate solitons is the cascading of two quadratic nonlinear effects. In this process, a strong pump beam will create an effective intensity-dependent nonlinearity through a two-step conversion process. For example, FIG. 2 shows the cascaded nonlinear process using second harmonic generation, where a strong second harmonic beam (50) can be used to amplify a weak fundamental beam (40) in a second order nonlinear crystal (60). Once the fundamental beam attains sufficient power and the harmonic is depleted (41), the reverse process occurs. The harmonic beam undergoes two different conversion processes, each of which is field dependent; the net effect is a resultant intensity dependence. Though the effect is predicated on the harmonic beam, because the conversion process couples the harmonic and fundamental waves very strongly, the fundamental (42) also experiences soliton formation. In addition, this process can occur in nearly any combination of beams in a three-wave mixing process such as sum frequency generation (SFG) and difference frequency generation (DFG), also known as optical parametric amplification (OPA).

Both third-order and cascaded quadratic optical nonlinearities have been used to generate solitons in a variety of media. These experimental investigations have demonstrated both temporal and spatial solitons. The most prominent example of temporal soliton formation is that observed in single-mode optical fibers. Spatial solitons have been demonstrated in planar waveguide structures fabricated from semiconductor materials as well as high nonlinearity glasses and crystals. In addition, multi-dimensional soliton formation has also been observed, where the size and shape are maintained in time and one transverse spatial dimension or in two transverse spatial dimensions. However, multi-dimensional soliton formation requires that the nonlinearity have additional components to the intensity dependence. In the case of third-order optical nonlinearities, these additional components can manifest as saturation of the nonlinearity or as higher-order intensity dependencies (i.e. n=n₂I+n₃I²). In the case of cascaded quadratic nonlinearities, the nonlinearity is naturally saturating as a result of the eventual depletion of the energy in the beams during the conversion processes.

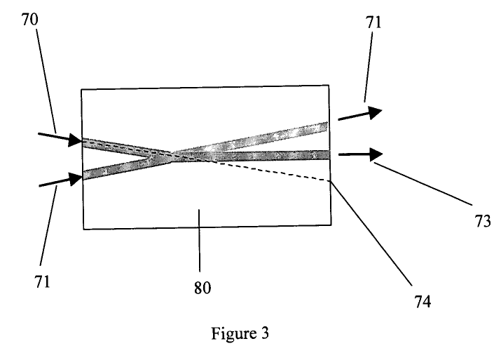

Not only does this higher-order nonlinear behavior allow for the formation of 2D solitons, it also enables a unique inelastic behavior between colliding solitons. In materials with traditional third-order nonlinearities, colliding solitons do not experience any form of energy transfer. Thus, two colliding soliton beams will essentially pass cleanly through one another, with neither beam affecting the other. As shown in FIG. 3, in materials with modified third-order or cascaded quadratic nonlinearities (80), colliding solitons can interact with one another,. This interaction can result in a phenomenon known as soliton dragging, where one beam (71) effectively “pulls” the other beam (70), altering the trajectory of the second beam (74) in the direction of the first (73). In addition, this interaction can be controlled via relative differences in the two beams. As an example, models of beam propagation in a modified third-order nonlinear material have indicated that collisions between a weak beam and a strong beam results in the weak beam being pulled in the direction of the stronger beam. This process has also been used in cascaded quadratic nonlinear materials to demonstrate switching. The switching process is shown graphically in FIG. 3. Soliton formation via third-order or cascaded quadratic optical nonlinearities modified by the higher-order nonlinearities that enable inelastic soliton collisions form the basis of the all-optical signal regenrator.

B. Products

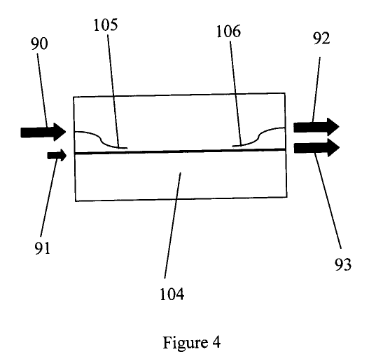

The design will use cascaded quadratic optical nonlinearities as shown schematically in FIG. 4. This device utilizes soliton formation in an optical parametric amplification process to provide signal regeneration. The system engine is based on a waveguide fabricated from a second-order, or quadratic nonlinear optical material (104). The signal (91) is input into the channel waveguide and simultaneously, a pump beam (90) at half of the wavelength of the signal is also directed collinearly into the waveguide via a multiplexer (105). After propagating through the waveguide the output signal (93) and pump beams (92) are separated by a demultiplexer (106). As a result of the parametric amplification, the signal will experience gain simultaneously with the rest of the regeneration process, providing the first of the 3 Rs. The pump beam is pulsed and synchronized to the system clock via a clock recovery circuit. Due to the cascaded quadratic nonlinear process, the signal and pump beams will form a strongly coupled pair resulting in the formation of temporal solitons. The process is configured to provide a threshold condition for soliton formation based on the power of the signal. This threshold condition will be used to eliminate optical noise in regions where no signal pulses exist. The soliton formation combined with the threshold behavior will naturally re-shape the signal beam, resulting in the second of the 3 Rs. Finally, because of the coupling, the beams will effectively collide temporally causing the weaker signal beam to be pulled forward or pushed backward in time to coincide with the pump beam, resulting in the re-timing of the signal pulse to the clock, providing the last of the 3 Rs. The soliton formation process and simultaneous temporal collision combined with parametric amplification produces all-optical 3R regeneration. Material considerations are critical and fortunately, waveguides in periodically poled lithium niobate (PPLN) and potassium titanyl phosphate (KTP) have already been demonstrated.

C. Regenerator Design

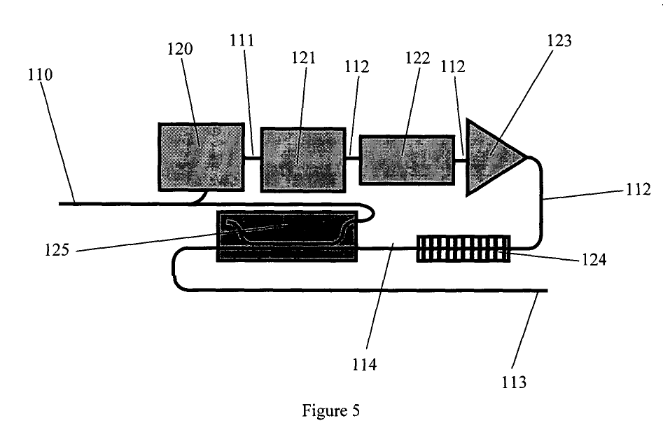

The initial product development efforts will be directed at all-optical regeneration, and the device will be based on the cascaded quadratic nonlinear phenomena as described in the previous section and shown in FIG. 4. The detailed device design is shown in FIG. 5. The 1550 nm optical clock is generated by a mode-locked laser (121) that is synchronized to the system clock (111) supplied by the clock recovery system (120). The optical clock output (112) is fed through a delay line (122), amplified (123), and then doubled to 775 nm (114) in a periodically poled lithium niobate (PPLN) waveguide (124) designed to maximize second harmonic generation. The signal beam and the doubled pump are fed into a second PPLN waveguide (125) in which the 3R takes place. The system design uses nearly all off-the-shelf components and consequently can be constructed quickly and very cost effectively. The components and manufacturers are shown in Table 1.

TABLE 1
Components and manufacturers for the all-optical 3R regenerator.

| Part | Manufacturer |
|---|---|
| PPLN SHG Waveguide | INO |
| Optical Splitter | JDS Uniphase |
| Clock Recovery | JDS Uniphase |
| EDFA | IPG Photonics |
| 2nd Order Waveguide (3R) | INO |
| Optical Clock | Pri-Tel |
| PCB with Microwave WG | MA/Com |
| Optical Connectors | FIS Fiber |
| Electrical Connection | Newark |
| PhotoDiode w/TIA | Discovery Semiconductor |

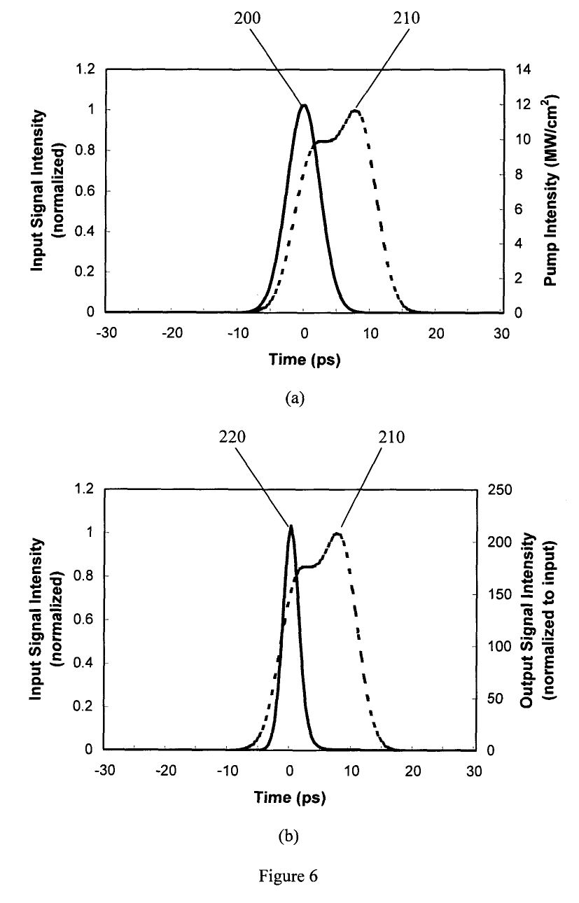

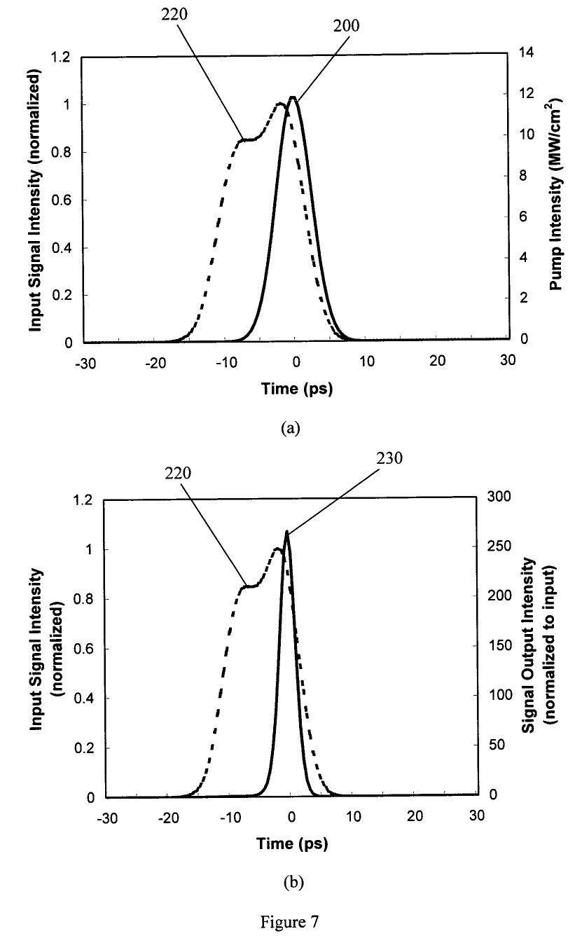

To evaluate the design of the all-optical 3R regenerator shown in FIG. 5, computer models have been developed. These numerical computations use a beam propagation method (BPM) to iteratively solve a form of the Nonlinear Schrödinger Equation (NLSE) modified to include the cascaded nonlinearity. The system is composed of one transverse dimension (time) and one propagation dimension. A split-step Fourier routine was used. FIG. 6(a) shows the signal input (210) and pump input (200) of the regenerator for a 5 ps offset. FIG. 6(b) shows the signal input (210) and signal output (220) for the input conditions in FIG. 6(a). FIGS. 7(a) and 7(b) show the same series of graphs for an offset of −5 ps. Clearly the simulations show that the 50 mm long 3R regenerator fabricated in lithium niobate (PPLN) will reshape the signal pulse, provide over 20 dB (100×) of amplification, and recover the timing with even a ±5 ps offset. In addition, the simulations show that for no signal beam, the pump beam propagates unaffected, and does not generate stray fluorescence. By selecting an appropriate power level for the pump, a threshold condition can be realized in which signals above the threshold experience regeneration and those below the threshold do not.

D. Multiple Channel Regenerator Design

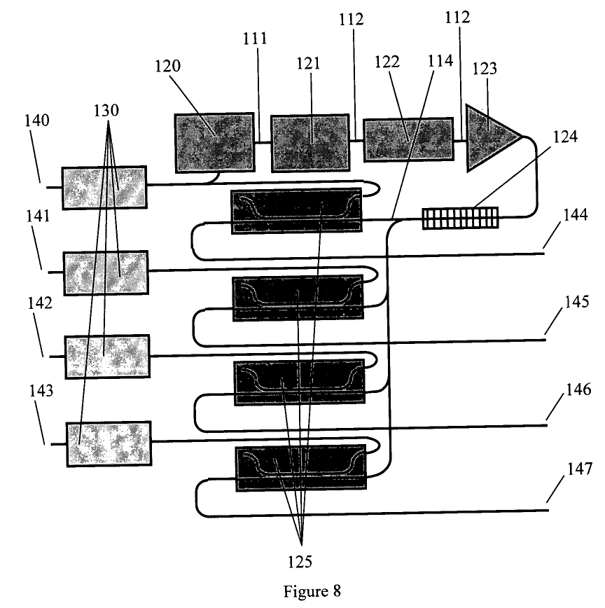

The cascaded quadratic nonlinearity can also be used to provide multi-channel capable all-optical 3R regeneration. In this design, the nonlinear parametric amplification process is utilized in a non-degenerate format, whereby the pump and signal wavelengths are not restricted to a simple harmonic relationship. Thus, a single pump can be used to regenerate multiple, different wavelengths. The number of wavelengths that can be regenerated is limited only by the available pump power. The only restriction on the multi-channel system is that it is polarization sensitive, which must be compensated for with polarization controllers at the input. Nonetheless, as the number of wavelengths that can be handled by a single system increases, the cost per wavelength is reduced, even including the cost of the polarization controllers. A four-wavelength capable all-optical regenerator is shown in FIG. 8. Relative to that shown in FIG. 5, this design incorporates 3 additional PPLN waveguides (125), a high-power splitter for the 775 nm pump (114), and 4 polarization controllers (130). Even with the additional components, the system is still constructed from off-the-shelf devices. Furthermore, numerical simulations of the non-degenerate process are identical to those used to simulate the type II degenerate process of the single-channel regenerator and thus bear out all of the same performance attributes and consequent benefits.

While the invention has been particularly shown and described with reference to preferred embodiment(s) thereof, it will be understood by those skilled in the art that various changes in form and details may be made therein without departing from the spirit and scope of the invention.

1. An all-optical regenerator, comprising:
an optical signal input node for receiving an input optical signal, the input optical signal including data; and
a regenerator waveguide receiving the input optical signal and an optical clock signal, and producing an output optical signal re-timed according to the optical clock signal and re-shaped according to the data in the input optical signal.

2. The all-optical regenerator of claim 1, wherein the regenerator waveguide provides amplification of the output optical signal relative to the input optical signal.

3. The all-optical regenerator of claim 2, wherein the regenerator waveguide employs temporal soliton interactions.

4. The all-optical regenerator of claim 3, wherein the temporal soliton interactions include cascaded quadratic non-linear solitons or saturating third-order non-linear solitons.

5. The all-optical regenerator of claim 1, further comprising:
a clock recovery unit for recovering timing information from the input optical signal; and
an optical clock generator to produce the optical clock signal synchronous with the timing information recovered by the clock recovery unit.

6. The all-optical regenerator of claim 5, wherein the optical clock generator includes a mode-locked laser, an optical delay line, an optical amplifier and an optical frequency doubler, cascaded in series, to generate the optical clock signal.

7. The all-optical regenerator of claim 5, further comprising:
a plurality of optical signal input nodes each for receiving a respective input optical signal at a respective wavelength; and
a plurality of regenerator waveguides each receiving a respective input optical signal and the optical clock signal, and producing a respective output optical signal at its respective wavelength re-timed according to the optical clock signal and re-shaped according to the data in its respective input optical signal, wherein the optical clock signal is synchronous with the timing information recovered from one of the input optical signals, and shared between the plurality of regenerator waveguides.

8. A method for all-optical regeneration, comprising:
receiving an input optical signal, the input optical signal including data;
receiving the input optical signal and an optical clock signal into a regenerator waveguide; and
producing an output optical signal re-timed according to the optical clock signal and re-shaped according to the data in the input optical signal.

9. The method of claim 8, wherein the regenerator waveguide provides amplification of the output optical signal relative to the input optical signal.

10. The method of claim 9, wherein the regenerator waveguide employs temporal soliton interactions.

11. The method of claim 10, wherein the temporal soliton interactions include cascaded quadratic non-linear solitons or saturating third-order non-linear solitons.

12. The method of claim 8, further comprising:
recovering timing information from the input optical signal; and
producing the optical clock signal synchronous with the timing information recovered by the clock recovery unit.

13. The method of claim 12, further comprising:
using a mode-locked laser, an optical delay line, an optical amplifier and an optical frequency doubler, cascaded in series, to generate the optical clock signal.

14. The method of claim 12, further comprising:
receiving a respective input optical signal at a respective wavelength at each of a plurality of optical signal input nodes; and
using a plurality of regenerator waveguides each receiving a respective input optical signal and the optical clock signal, and producing a respective output optical signal at its respective wavelength re-timed according to the optical clock signal and re-shaped according to the data in its respective input optical signal, wherein the optical clock signal is synchronous with the timing information recovered from one of the input optical signals, and shared between the plurality of regenerator waveguides.
